(19) United States
(12) Patent Application Publication
(10) Pub. No.: US 2013/0285857 A1
(43) Pub. Date: Oct. 31, 2013

(54) ANTENNA ARRANGEMENT

(71) Applicants: John Colin SCHULTZ, Mawson Lakes (AU); David Malcolm HALL, Mawson Lakes (AU)

(72) Inventors: John Colin SCHULTZ, Mawson Lakes (AU); David Malcolm HALL, Mawson Lakes (AU)

(21) Appl. No.: 13/661,453

(22) Filed: Oct. 26, 2012

(30) Foreign Application Priority Data
Oct. 26, 2011 (AU) 2011904444

(51) Int. Cl. H01Q 5/00

(52) U.S. Cl. CPC H01Q 5/0027
USPC 343/700 MS

(57) ABSTRACT

Disclosed are antennas for printed circuit boards (PCB) including a printed circuit board having antenna conductors, ground plane, an insulating substrate and a feed structure. The antenna is at least partially formed by an array of two similarly sized and shaped antenna elements. Each antenna element is oriented substantially orthogonal to the other and similarly positioned relative to the ground plane. The two antenna elements are coupled to the feed structure and are connectable to a transceiver such that when the two like antenna elements are fed differentially the far fields of each antenna are substantially similar and substantially orthogonal to each other so as to provide substantial omni-directionality.

### RELATED APPLICATION

The present application claims priority from Australian Patent Application Serial No. 2011904444, filed on Oct. 26, 2011. Applicants claim priority under 35 U.S.C. §119 as to said Australian application, and the entire disclosure of said application is incorporated herein by reference.

### TECHNICAL FIELD

The present invention relates to the field of antennas for printed circuit boards (PCB).

### BACKGROUND

Monopole antennas implemented using PCB etching techniques have provided compact antenna solutions for wireless communication devices that have both reasonable efficiency and omni-directionality. The Inverted-F or Folded-L monopole antenna, where the antenna element and ground plane are in common planes, is popular since it requires only one conductor layer on a circuit board.

Antennas are often crowded for space in miniaturised electronic devices, and as a result the balance of antenna geometry which would normally result in good omni-directional characteristics are often compromised to make the antenna fit into a space made available. Add to this the requirement for a backup diversity antenna and available space is stressed even more.

Antenna conductors can be integrated on a main PCB using external tracks or internal tracks of a multi-layer PCB, or externally combined or connected to a main PCB using other forms of conductive elements such as metal strips, wire, plates, or tracks on other minor PCBs and are not necessarily incorporated into or restricted to the plane of a main PCB.

A wireless communication device may be referred to as a transceiver but it is to be understood that the wireless communication device could be a transmitter, a receiver, or a transceiver without departing from the scope of the invention.

### SUMMARY

In a first aspect the present invention accordingly provides an antenna arrangement for a wireless communication device including a printed circuit board having antenna conductors, ground plane, an insulating substrate and feed structure wherein said antenna conductors form an array of two similarly sized and shaped antenna elements where each antenna element is oriented substantially orthogonal to the other and similarly positioned relative to the ground plane, and where the two antenna elements are respectively coupled to the feed structure and are connectable to said device, such that when the two like antenna elements are fed differentially the far fields of each antenna are substantially similar and substantially orthogonal to each other so as to provide substantial omni-directionality.

In one illustrative embodiment the antenna arrangement consists of two antennas placed such that at least two edges of the ground plane are orthogonal to each other and the array of two antennas are arranged symmetrically about the apex of the two edges of the ground plane. Where one antenna may have a local minima in field magnitude with a certain polarisation in a particular direction, the second antenna will be differently oriented and so will not have a minima in field magnitude in the same polarisation and direction.

The two antennas each have electrically small elements of length less than one quarter wavelength in air but since the two antenna array is physically distributed over a distance comparable to one quarter wavelength in air, the array exhibits a built-in diversity characteristic. The combined antenna arrangement receives sufficient signal amplitude when moved in a radio reflective environment, otherwise described as a multi-path environment.

In another aspect of the invention, a feed structure is used to electrically connect a wireless communication device to the antenna elements. The feed structure may consist of a transmission line either integrated on or separate to the PCB, or PCB tracks and tuning components either discrete or integrated on the PCB. Examples of transmission lines integrated on the PCB are stripline, microstrip, coupled stripline, coupled microstrip (twin conductor parallel line over a ground plane), and coplanar waveguide. An example of a transmission line separate to the PCB is a coaxial line.

The feed structure can be designed to accommodate transceivers with a differential or single-ended antenna drive. A differential drive has two terminals, both separate to the system ground, where the signals between each terminal and system ground respectively exhibit a non-zero phase difference.

In a further aspect of the invention the capacitively coupled connection between a feed structure and a respective antenna conductor that feeds the antenna element is formed by track portions which overlap each other on different conductive layers of the PCB.

Additionally the arrangement and geometry of PCB tracks can provide in an aspect a feed and bias solution that requires no additional components between antenna and transceiver.

### BRIEF DESCRIPTION OF THE DRAWINGS

An illustrative embodiment of the present invention will be discussed with reference to the accompanying drawings wherein:

FIG. 1a depicts a typical Inverted-F monopole antenna where the antenna element and ground plane are etched from a common conductor sheet bonded to a flat face of a supporting insulating substrate;

FIG. 1b depicts a Folded-L monopole antenna with features similar to FIG. 1a except that the feed-point is connected to the base section rather than the folded section of the antenna;

FIG. 1c depicts another Folded-L monopole antenna with features similar to FIG. 1a except that the feed-point is across a gap between the base section of the antenna and the ground plane;

FIG. 2 depicts two Folded-L monopole antennas placed symmetrically about the apex of a ground plane;

FIG. 3a depicts the stacking of a two antenna array in accordance with an illustrative embodiment of the present invention, where two etched conductor sheets would be bonded to the flat faces of a separating insulating substrate;

FIG. 3b depicts the plan view of the two antenna array of FIG. 3a;

FIG. 4 depicts a Quad antenna where part of the antenna conductors and ground plane are etched from a common conductor sheet bonded to a flat face of a supporting insulating substrate, and a remaining part of the antenna conductors are separate but connected to the main substrate;

FIG. 5a depicts an antenna with a folded end and another with a meandered track;

FIG. 5b depicts a section of microstrip line and a section of microstrip line which has been meandered;

FIG. 6a depicts a transceiver with a differential signal driving capability;

FIG. 6b depicts an arrangement where a single ended transceiver is coupled to a differential drive using a phase splitter;

FIG. 7a depicts a section of microstrip line and a section of coupled microstrip line;

FIG. 7b depicts a section of stripline and a section of coupled stripline;

FIG. 7c depicts a section of coplanar waveguide; and

FIG. 7d depicts a section of coaxial cable.

### TECHNICAL DESCRIPTION

Antennas described herein are useful when creating products that are handheld or have restrictions of size and/or weight. These types of antenna are compact and reliable, generally since they have nil or few electronic discrete components. Non-limiting examples of the use of such antennas is in products such as handheld user operated remote control devices, or for incorporation into devices that have space restrictions. Further since they can be used in Ultra High Frequency wireless systems their size and advantageous transmission and reception characteristics can be advantageous.

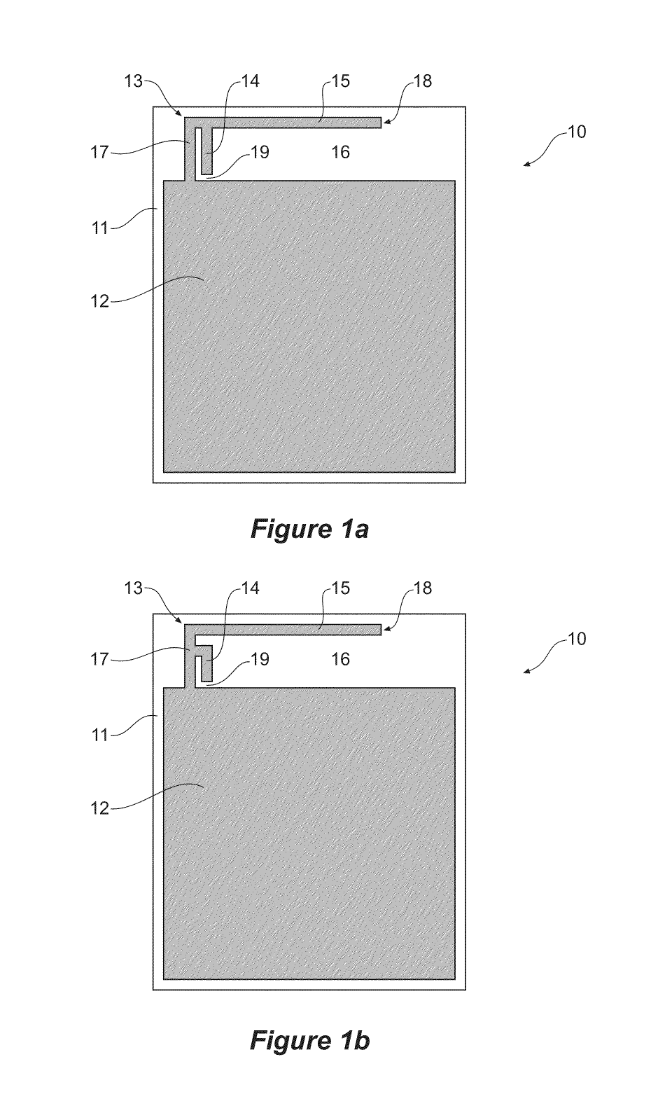

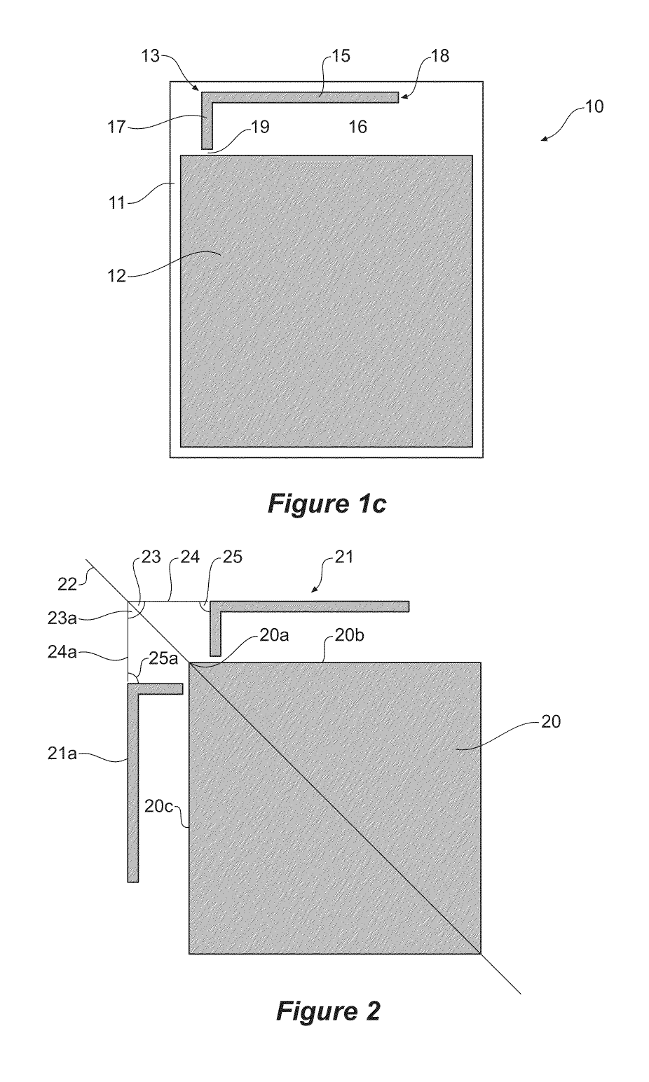

The Inverted-F monopole of FIG. 1a shows PCB 10 with insulating supporting substrate 11, ground plane 12, and antenna element 13 which is etched from the same layer as ground plane 12. The antenna element has two main conductors; track 15 separated by a distance 16 to ground plane 12 and track 17 which connects track 15 to ground plane 12. Track 15 has an open end 18. Feed track 14 is shown with a gap 19 between itself and ground plane 12. This gap forms the terminals of the antenna element and would typically be connected to a transceiver chip by a further feed structure such as coaxial cable, PCB tracks, or an integrated transmission line which may be etched from a conductive layer of the PCB.

In the case where the transmission line is integrated on the PCB and the signal track is formed on a layer different to the ground plane, it may be connected with a through-hole via or similar method to electrically connect two PCB layers together. A capacitive coupling between the antenna elements and a feed structure can be provided as a gap in a common conductive layer or over-lapping plates formed from two or more different conductive layers. In one embodiment the capacitive connection is formed by conductive track portions on different layers of the printed circuit board which overlap each other and which are orthogonal to one another.

The antenna conductors may be implemented as antenna tracks using an etched PCB. The monopole shown is a good choice of antenna to be embedded on a PCB since it works in the presence of a ground plane which would otherwise be present to provide the necessary ground for the transceiver and other high frequency or noise sensitive components and transmission lines of a complete device.

By adjusting the length of the main conductor 15 and the distance 16 to the ground plane 12 (which changes the length of main conductor 17), the radiating fields in the two main polarisations may be balanced. The currents flowing horizontally, left-right in the page produce horizontally polarised far fields. The currents which flow vertically, up-down in the page produce vertically polarised far fields. By balancing these two sources of field the antenna element can ideally be made multi-directional. However with the introduction of variables such as product packaging, size and shape of ground plane and other conductors, and location of product circuitry, the balance in the two main polarisations may be deficient.

The Folded-L monopole of FIG. 1b shows a PCB 10 with insulating supporting substrate 11, ground plane 12, and antenna element 13 which is etched from the same layer as ground plane 12. The antenna element has two main conductors; track 15 separated by a distance 16 to ground plane 12 and track 17 which connects track 15 to ground plane 12. Track 15 has an open end 18. Feed track 14 is shown with a gap 19 between itself and ground plane 12 which forms the antenna terminals. The main difference between the Folded-L monopole as shown in FIG. 1b and the Inverted-F monopole as shown in FIG. 1a is the connection of feed track 14 to track 17 rather than to track 15.

The alternate Folded-L monopole of FIG. 1c shows a PCB 10 with insulating supporting substrate 11, ground plane 12, and antenna element 13 which is etched from the same layer as ground plane 12. The antenna element has two main conductors; track 15 separated by a distance 16 to ground plane 12 and track 17 which connects track 15 to gap 19 which forms the antenna terminals. Track 15 has an open end 18. The main difference between the alternate Folded-L monopole as shown in FIG. 1c and the Folded-L monopole as shown in FIG. 1b is the feed-point is between track 17 and the ground plane 12 rather than between a track 14 and the ground plane 12.

FIG. 2 depicts two Folded-L monopole antenna elements 21 and 21a placed symmetrically about the apex 20a of a corner of a ground plane 20. Construction line 22 splits the apex 20a equally. Construction lines 24 and 24a, respectively parallel to ground plane edges 20b and 20c, are drawn from each antenna element to construction line 22 and result in equal angles 23 and 23a, and equal angles 25 and 25a showing that the two antenna elements are placed symmetrically about the apex 20a.

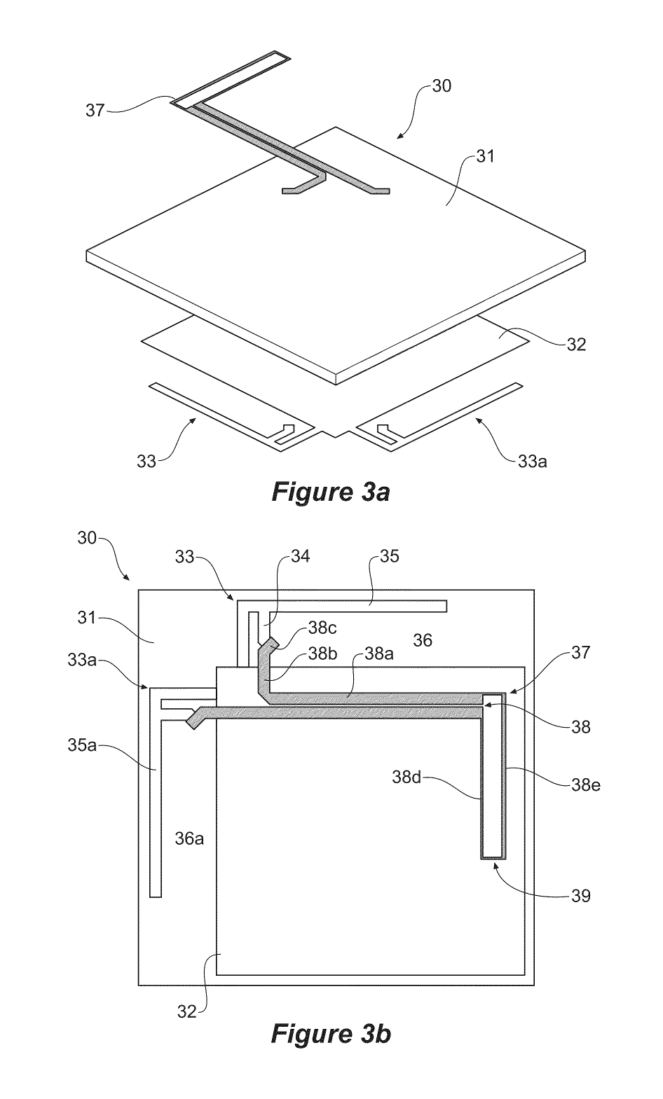

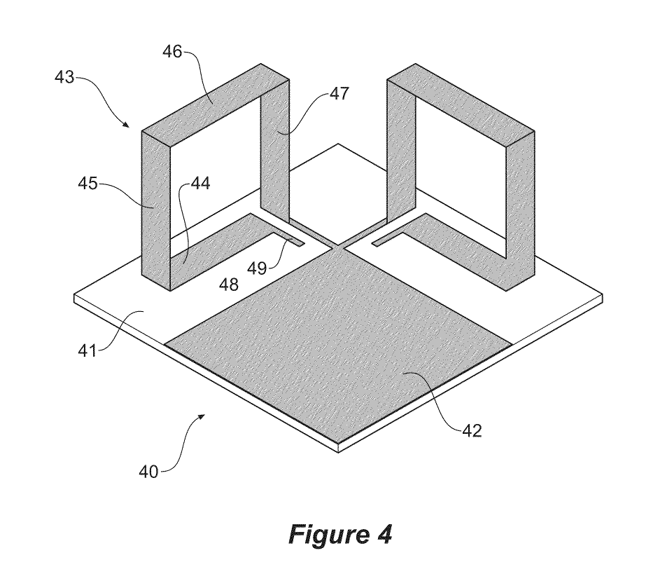

FIG. 3a shows the stack of layers which make up the antenna arrangement in accordance with one illustrative embodiment of the current invention. PCB 30 is comprised of insulating separating substrate 31, a lower layer with etched ground plane 32 and antenna elements 33 and 33a which are etched from the same lower layer as ground plane 32. An upper layer is etched with a feed structure 37.

In the embodiments depicted the printed circuit board has at least two layers and the feed structure formed by parallel conductive tracks on one layer is located so as to overlap a portion of the ground plane located on another layer of the printed circuit board.

FIG. 3b shows a plan view of the antenna arrangement in accordance with an illustrative embodiment of the present invention. PCB 30 is comprised of insulating separating substrate 31, a lower layer with etched ground plane 32 and antenna elements 33 and 33a which are etched from the same lower layer as ground plane 32. An upper layer is etched with a feed structure 37. When main conductor length 35 is not ideally related to the distance 36 to the ground plane 32, the omni-directional characteristics of the two main polarisations of a single antenna element may be deficient. With the addition of a second antenna element 33a of different orientation which has a main conductor 35a and a corresponding distance 36a to ground plane 32, the balance in polarisation is restored and the array becomes substantially omni-directional. The placement of the antennas symmetric about the apex of a ground plane corner makes them substantially orthogonal to each other and in particular the separation between the antenna elements is adjusted to further enhance the overall array's omni-directional characteristic, while also providing a degree of immunity to multi-path signals eliminating the need for addition diversity antennas.

Terminal pair 38 connects to a transceiver with a differential port and is further connected to the antenna elements by a feed structure shown in this embodiment as a coupled microstrip transmission line. Part of the coupled microstrip line 38a connects via track 38b to capacitor plate 38c. In this embodiment conductive areas of the PCB are used in a capacitive coupling arrangement. Capacitor plate 38c couples to a matching plate on antenna feed track 34 of another conductor sheet. The capacitor plates are aligned at 45 degrees to the centreline of connecting track 38b and have an overlap of greater than the square root of 2 times the larger of the two delta tolerances due to processing the stack of the conductor sheets. This technique minimises variations in capacitance over the PCB manufacturing process variations. An alternative is to provide a discrete capacitive component but this is less desirable because it adds cost and volume. The transmission line 38a may be meandered (made to follow a winding or zigzag path) so as to increase the electrical length within the physical space available.

The antenna may not be required to be capacitively coupled, but in an embodiment requiring the feed terminals or transceiver port to be direct current (DC) isolated from the ground plane, any integrated tuning capacitors present in the antenna feed structure may be exploited for dual use, acting as both DC isolation as well as impedance matching (or antenna tuning).

Tracks 38d connect the terminals 38 of the chip or transceiver port to point 39 where a DC bias voltage is provided along the DC current path formed by track 38d. The length of the two individual tracks 38d and 38e between the port terminals 38 and DC bias point 39 are adjusted to be substantially one quarter wavelength in the dielectric of the substrate so as to minimise loading the radio port by the biasing point 39, which commonly has a shunt reservoir or bypass capacitor to ground which presents a low impedance path from bias point 39 to ground at radio frequencies. The bias lines 38d and 38e may be meandered so as to increase the electrical length within the physical space available.

In one embodiment direct current bias is provided by transmission lines which have electrical lengths of substantially one quarter wavelength in the dielectric of the transmission line.

The result is a fully integrated antenna arrangement requiring no discrete components for impedance matching (or antenna tuning) and DC biasing of the transceiver.

Other embodiments using transceivers with a single ended port may be implemented by feeding the antenna arrangement with a different transmission line and a single biasing track, such an embodiment still preserving the desirable features of the current invention.

Other embodiments may have antenna track 15 in a parallel or orthogonal plane with feed track 14 connected to antenna track 17 as appropriate.

Another embodiment may implement feed structures 38a and 38e as a coaxial cable.

The element lengths 35, 35a are shown straight but may be meandered or have the open end of the track end folded away from or towards the ground plane 32 in order to increase the electrical length of the main elements within the physical space available.

FIG. 4 shows a PCB 40 with insulating supporting substrate 41, ground plane 42 and antenna element 43 which has antenna conductor 44 etched from the same layer as ground plane 42 and antenna conductors 45, 46 and 47 formed separately. The antenna element has conductor 44 separated by a distance 48 to ground plane 42. Feed track 49 is shown with a gap between itself and ground plane 42. This gap forms the terminals of the antenna element and would typically be connected to a transceiver via a feed structure such as matching network or transmission line. The PCB has at least two layers which are in this embodiment formed on opposite sides of the typically planar PCB having an insulating substrate there between. The thickness of the insulating substrate is typically standardized but that should not be limiting in any way on the scope of the invention as alternative substrate configurations and thicknesses may be usefully employed in providing the functionality required of the invention.

By adjusting the length of conductors 44, 45, 46, and 47 and the distance 48 to the ground plane 42, the angle formed between the radiating field and the ground plane may be set substantially to 45 degrees. By balancing this field angle, the antenna element spacing, and the feed-point phase difference between the two antenna elements the field of the antenna arrangement can be made substantially omni-directional.

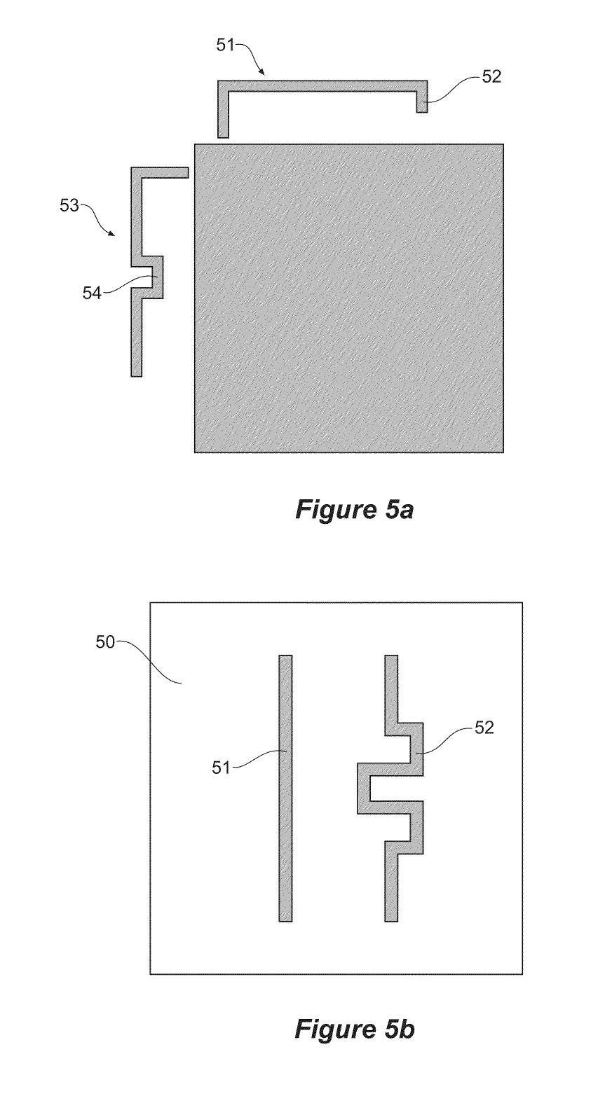

FIG. 5a shows an antenna 51 with a folded end 52 and another antenna 53 with a meandered track 54.

FIG. 5b shows a section 51 of microstrip line on a first conductive layer and a ground plane 50 on a second conductive layer. Microstrip line section 52 has been meandered.

The antenna arrangements described in this specification are preferably connected to a differential port where both antennas of the array are simultaneously connected. The signals at the two antennas exhibit a non-zero phase difference. Preferable phase differences are 90 degrees or 180 degrees. To utilise the embodiments of the invention with single ended ports a single ended to differential conversion is required and this is typically achieved with a phase splitter such as a network or balun, the components of which may be fully integrated on the PCB or formed by discrete components. The embodiment of the phase splitter is preferred so as to utilise a fully integrated solution using PCB tracks for all or the majority of elements of the antenna arrangement.

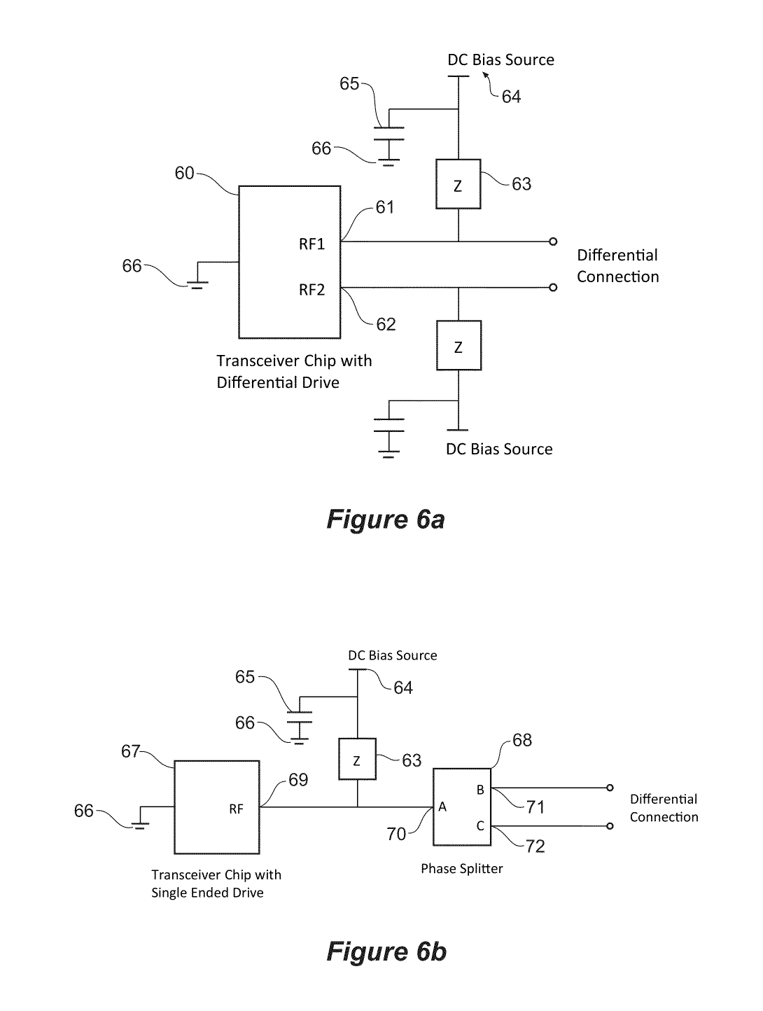

FIG. 6A shows a transceiver chip 60 with differential terminals RF1 61 and RF2 62 and ground connection 66. If a DC bias is required by the chip, terminal RF1 61 is connected via impedance 63 to DC Bias Source 64 which is decoupled to ground 66 using decoupling capacitor 65. A similar structure can be used for terminal RF2 62 if required. The impedance 63 is designed to be of high impedance at the frequency of operation. This impedance may be implemented using an inductor or a transmission line of electrical length of one quarter wave at the frequency of operation. This inductor or transmission line could be fully integrated on the PCB using PCB tracks or discrete components. The terminals RF1 61 and RF2 62 are then connected to a differential feed structure subsequently connected to the antenna array.

FIG. 6B shows a transceiver chip 67 with a single ended terminal RF 69 and ground connection 66. If a DC bias is required by the chip, terminal RF 69 is connected via impedance 63 to DC Bias Source 64 which is decoupled to ground 66 using decoupling capacitor 65. Terminal RF 69 is connected to Phase Splitter port A 70. The signal at phase splitter port A 70 is split into two phases at ports B 71 and C 72 which are respectively connected to a differential feed structure which is connected to the antenna array.

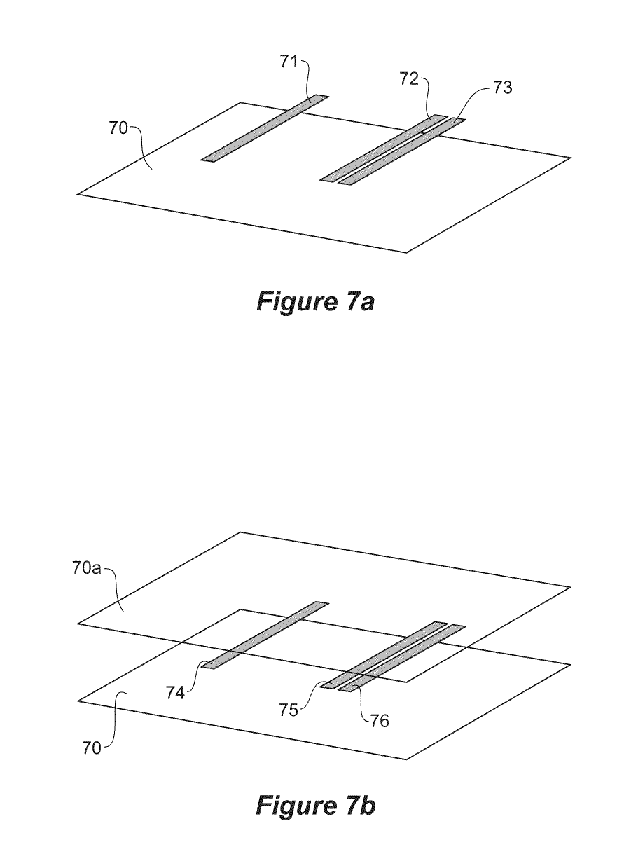

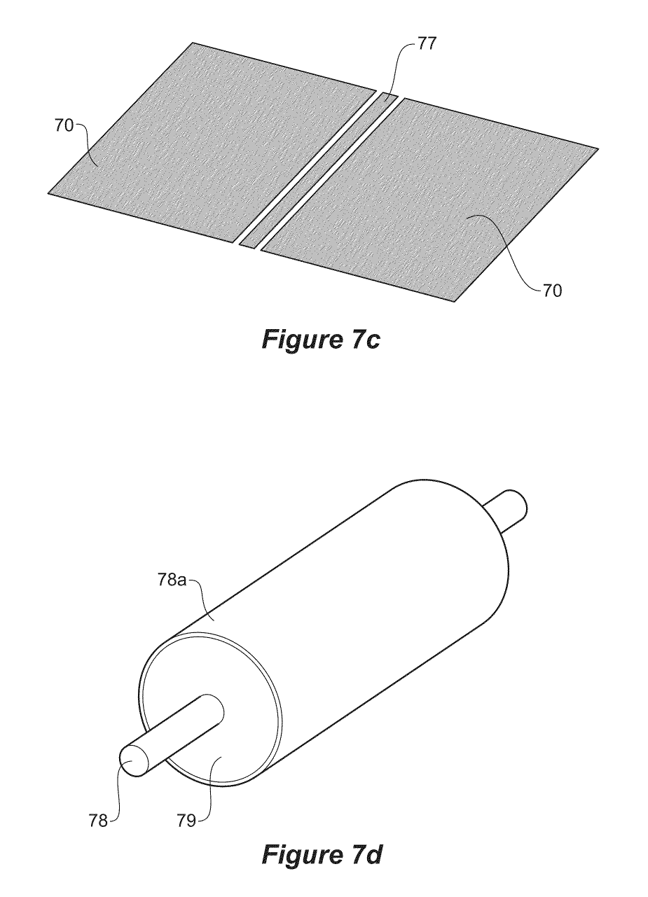

FIG. 7a shows a section of microstrip line formed by signal track 71 and ground plane 70 which is on a different conductive layer to track 71. The insulating and supporting substrate of the PCB is not show but will be understood to be between or to surround track 71 and ground plane 70. A section of coupled microstrip line is shown with signal tracks 72 and 73 on a common layer and ground plane 70 which is on a different conductive layer to tracks 72 and 73.

FIG. 7b shows a section of stripline formed by signal track 74 and ground planes 70 and 70a which are respectively on a different conductive layer to track 74. The insulating and supporting substrate of the PCB is not show but will be understood to be between or to surround ground planes 70 and 70a. A section of coupled stripline is shown with signal tracks 75 and 76 on a common layer and ground planes 70 and 70a which are respectively on different conductive layers to tracks 75 and 76.

FIG. 7c shows a section of coplanar waveguide with signal track 77 formed within a gap in a ground plane 70, with both track 77 and ground plane 70 in a common conductive layer. The PCB substrate is not shown but is understood to support or surround track 77 and ground plane 70.

FIG. 7d shows a section of coaxial cable formed by inner conductor 78, outer conductor 78a and insulating and supporting substrate 79.

It will be understood that the term “comprise” and any of its derivatives (eg. comprises, comprising) as used in this specification is to be taken to be inclusive of features to which it refers, and is not meant to exclude the presence of any additional features unless otherwise stated or implied.

The reference to any prior art in this specification is not, and should not be taken as, an acknowledgement of any form of suggestion that such prior art forms part of the common general knowledge.

Although an illustrative embodiment of the present invention has been described in the foregoing detailed description, it will be understood that the invention is not limited to the embodiment disclosed, but is capable of numerous rearrangements, modifications, and substitutions without departing from the scope of the invention as set forth and defined by the following claims.

1. An antenna arrangement for a wireless communication device including:
a printed circuit board having antenna conductors, ground plane, an insulating substrate and feed structure wherein said antenna conductors form an array of two similarly sized and shaped antenna elements where each antenna element is oriented substantially orthogonal to the other and similarly positioned relative to the ground plane, and where the two antenna elements are respectively coupled to the feed structure and are connectable to said device, such that when the two like antenna elements are fed differentially the far fields of each antenna are substantially similar and substantially orthogonal to each other so as to provide substantial omni-directionality.

2. The arrangement of claim 1 wherein at least two edges of the ground plane are substantially orthogonal to each other and the antenna elements are arranged symmetrically about the apex of the two edges of the ground plane.

3. The arrangement of claim 1 wherein the printed circuit board has at least two layers and the feed structure formed by parallel conductive tracks on one layer is located so as to overlap a portion of the ground plane located on another layer of the printed circuit board.

4. The arrangement of claim 3 where the feed structure is a coupled microstrip line or coupled stripline.

5. An antenna arrangement for a wireless communication device having a transceiver, the antenna arrangement including:
a printed circuit board having antenna conductors, ground plane, an insulating substrate and feed structure wherein said antenna conductors form an array of two similarly sized and shaped antenna elements where each antenna element is oriented substantially orthogonal to the other and similarly positioned relative to the ground plane, and where the two antenna elements are respectively coupled to the feed structure and are connectable to said device, such that when the two like antenna elements are fed differentially the far fields of each antenna are substantially similar and substantially orthogonal to each other so as to provide substantial omni-directionality wherein the connectable connection across terminal ends of the feed structure for connection to the transceiver comprises in part direct current bias conductors.

6. The arrangement of claim 5 where the direct current bias is provided by transmission lines which have electrical lengths of substantially one quarter wavelength in the dielectric of the transmission line.

7. The arrangement of claim 1 further including a capacitive connection between the feed structure and the antenna elements.

8. The arrangement of claim 7 where the capacitive connection is formed by conductive track portions on different layers of the printed circuit board which overlap each other and which are orthogonal to one another.

9. The arrangement of claim 1 where antenna conductors forming a portion of each antenna element meanders.

10. The arrangement of claim 1 where the feed structure contains a meander line.

11. The arrangement of claim 1 where the feed structure contains a meander line.

12. The arrangement of claim 5 where the direct current bias conductors contain a meander line.

13. The arrangement of claim 1 where an antenna conductor forming a portion of each antenna element has an open end shaped to increase the electrical length of the antenna.

14. The arrangement of claim 1 where the antenna elements are Inverted-F monopoles.

15. The arrangement of claim 1 where the antenna elements are Folded-L monopoles.

16. The arrangement of claim 1 where the antenna elements are a Quad structure.

17. An arrangement of claim 1 where the wireless communication device is a transceiver, transmitter, or receiver.
